(19) United States
(12) Patent Application Publication
(10) Pub. No.: US 2006/0119210 A1
(43) Pub. Date: Jun. 8, 2006

(54) Spark-proof series wound motor

(75) Inventor: Tsung-Pin Ting, Taipei (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Primax Electronics Ltd.

(21) Appl. No.: 11/176,162

(22) Filed: Jul. 7, 2005

(30) Foreign Application Priority Data
Dec. 3, 2004 (TW) 093137447

(51) Int. Cl. H02K 13/10; H01R 39/46; H02K 13/14; H02K 13/06

(52) U.S. Cl. 310/220

(57) ABSTRACT

A spark-proof series wound motor includes a stator module, a rotor module, a plurality of electrical brush modules and a spark-proof mask. The spark-proof mask covers the contact portion where sparks possibly occur due to the abrasion between the electrical brush and the commutator. In this way, the sparks are confined within the spark-proof mask and prevented from striking other portions of the motor.

### FIELD OF THE INVENTION

The present invention relates to a series wound motor and more particularly to a spark-proof series wound motor.

### BACKGROUND OF THE INVENTION

An electrical motor is a machine for transforming electric energy into mechanical energy. In modem industries, an electrical motor is popularly used in various power mechanical fields due to its simple and efficient features. If discriminated according to power sources, an electrical motor can be a direct-current (DC) motor and an alternating-current (AC) motor. By way of supplying an electric current to a coil or an armature located in a magnetic field to magnetize the coil or armature, magnetic poles can be derived. Accordingly, electromagnetic torque can be generated in response to the electromagnetic induction resulting from the repulsive force between poles of the same polarity or attractive force between poles of different polarities. The electromagnetic torque then actuates a shaft coupled to the coil or armature to rotate. Alternatively, a commutator can be used to alternately change the current direction in the coil or armature so as to continuously rotate the shaft in the same direction in response to the electromagnetic torque.

In addition to DC motors and AC motors, electrical motors can also be classified according to different means of controlling, actuating or winding, etc. For example, if discriminated according to magnetic field types, an electrical motor can be a permanent magnetic motor operating with a permanent magnet or an excited magnetic motor operating with an excitation coil serially or parallelly coupled thereto. The electromagnetic induction function of the excitation coil provides the magnetic field required by the electrical motor. A series wound motor is the prominent one of the excited magnetic motors.

Please refer to FIG. 1 which schematically illustrates the resolved structure of a conventional series wound motor. The series wound motor comprises a stator module 10, a rotor module 20, a shaft holder 30 and a plurality of electrical brush modules 40. The stator module 10 has a housing 11 and comprises a magnetic winding (or working coil) 12 and a housing wire 13. The rotor module 20 comprises a shaft 21, a commutator 22 and an armature winding (or rotor coil) 23. The shaft holder 30 comprises a front tray 31, a rear tray 32, a front insulator 310 and a rear insulator 320. Each of the plurality of electrical brush modules 40 comprises an electrical brush 41, an electrical brush wire 42, a socket 43, a spring 44 and a coupler 45. The shaft 21 sleeved thereon the commutator 22 and armature winding 23, after penetrating through the housing 11 of the stator 10, is rotatably coupled to the front and rear insulators 310 and 230 inside the front and rear trays 31 and 32, respectively. The electrical brush 41 is inserted into the socket 43 and then penetrates the front tray 31 to be in contact with the commutator 22. The spring 44 urges the brush 41 against the commutator 22 to assure good electric contact. The coupler 45 is used to combine the electrical brush wire 42 with the electrical brush 41. Thus, an external current can be introduced into the commutator 22 through the electrical brush wire 42 and the electrical brush 41 to provide alternate current directions for the armature winding 23 in order to generate electromagnetic toque. Meanwhile, an external current is supplied to the magnetic winding 12 of the stator module 10 via the housing wire 13 to derive a magnetic field. The shaft 21 can thus continuously rotate in the same direction as mentioned above.

The motor having the above structure is so called as a series wound motor because the armature winding 23 and the magnetic winding 12 are electrically connected to each other in series. In a small-size motor, the armature winding is generally implemented with a wound enamel wire. On the other hand, the armature winding of a large-size motor is generally implemented with a pre-formed winding. The brush 41, depending on the material thereof, for example, can be a carbon brush, an electro-graphite brush, a bitumen/coke brush, a graphite brush or a metal-graphite brush. Since the brush 41 is subject to fierce abrasion with the commutator 22 when the rotor module 20 is operating high-speed rotation, high heat and high temperature are likely rendered. Moreover, sparks may be generated. Since the frictional portion of the brush 41 and commutator 22 where sparks may occur is exposed to the air, the motor might be a fire risk if the sparks strike the motor body and the material of the motor body is not heat-resistant enough.

### SUMMARY OF THE INVENTION

Therefore, the present invention provides a spark-proof series wound motor to protect the motor from possible sparks.

According to the present invention, a series wound motor comprises a stator module; a rotor module comprising a shaft rotatably inserted into the stator module and a commutator sleeved around and rotating with the shaft; at least one electrical brush module penetrating the stator module to be in contact with the commutator for introducing an external current to the commutator therevia; and a spark-proof mask covering a contact potion of the electrical brush module and the commutator for isolating sparks occurring due to the abrasion between the electrical brush module and the commutator.

In an embodiment, the spark-proof mask includes a hollow cylindrical body for covering the commutator. The hollow cylindrical body includes at least one through hole in the wall thereof and the spark-proof mask further includes at least one socket attached to the hollow cylindrical body aligned with the through hole for receiving therefrom the electrical brush module. Consequently, the electrical brush module penetrates through the socket and the through hole to reach the commutator.

In an embodiment, the hollow cylindrical body and the at least one socket are integrally formed. The spark-proof mask is made of thermosetting material or bakelite.

In an embodiment, the stator module comprises a hollow main body for accommodating therein the rotor module; a magnetic winding accommodated in the hollow main body for providing a magnetic field for the rotor module in response to an applied current; a front tray disposed at one side of the hollow main body for supporting one end of the shaft of the rotor module while allowing the shaft to rotate therein, and having at least one slot for penetrating therethrough the at least one electrical brush module to be in contact with the commutator; and a rear tray disposed at the opposite side of the hollow main body for supporting the opposite end of the shaft while allowing the shaft to rotate therein.

In an embodiment, the spark-proof mask is accommodated in the front tray and sustained against the hollow main body, and one end of the shaft inserted into the hollow main body penetrates through both the spark-proof mask and the front tray.

In an embodiment, the spark-proof mask comprises a main body accommodated in the front tray and at least one socket protruding from the main body and penetrating through the at least one slot.

In an embodiment, the rotor module further comprises an armature winding electrically connected to the commutator in series and sleeved around the shaft for generating an electromagnetic torque in response to the external current and the magnetic field.

In an embodiment, each of the at least one electrical brush module comprises a brush element to be in electric contact with the commutator; a conductive coupler electrically connected to the conductive flexible element for introducing therefrom the external current; and a conductive flexible element coupled to the conductive coupler for transmitting the external current therevia and urging the brush element against the commutator for facilitating the electric contact between the brush element and the commutator. Consequently, the brush element penetrates through the stator module and the spark-proof mask to be in contact with the commutator.

The conductive flexible element, for example, can be a spring.

### BRIEF DESCRIPTION OF THE DRAWINGS

The present invention may best be understood through the following description with reference to the accompanying drawings, in which:

FIG. 1 is a schematic resolving diagram showing a conventional series wound motor;

FIG. 2 is a schematic resolving diagram showing an embodiment of a series wound motor according to the present invention;

FIG. 3A is a schematic side view of the assembled series wound motor of FIG. 2 viewed from the point P; and

FIG. 3B is a schematic front view of the assembled series wound motor of FIG. 2 viewed from the point Q.

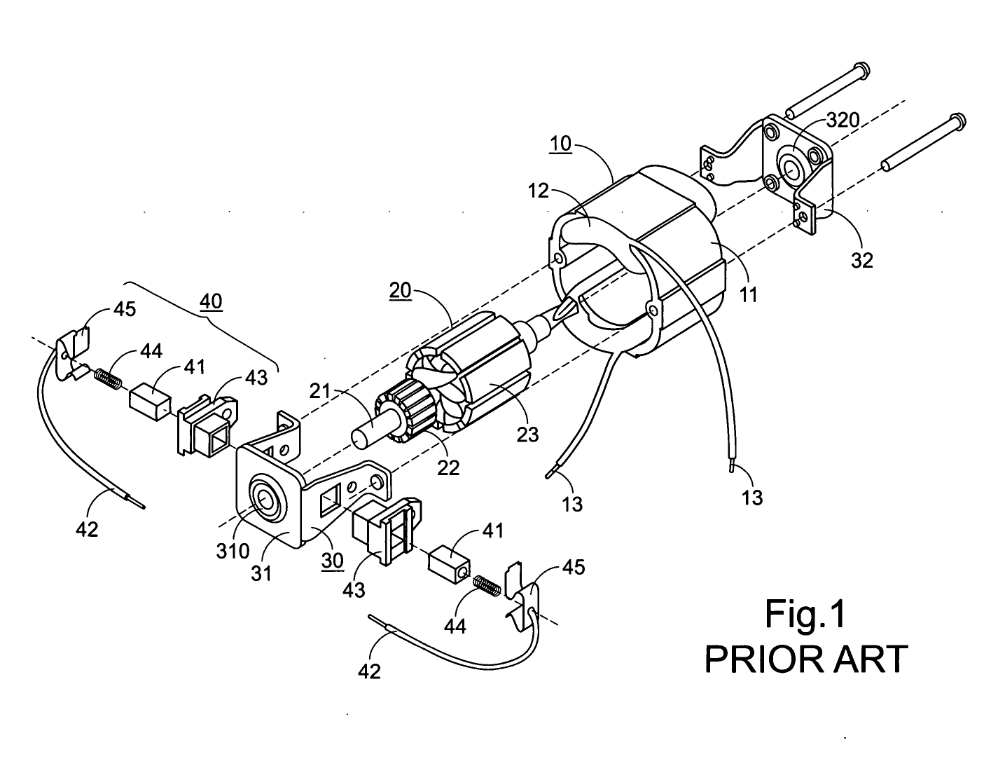

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

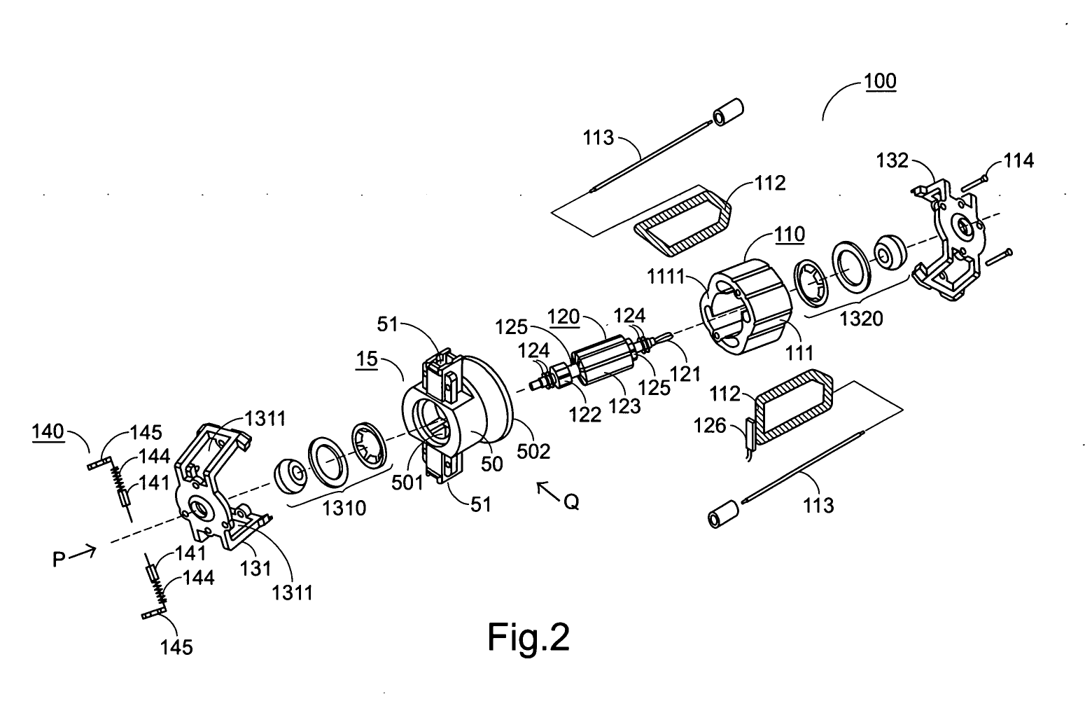

Referring to FIG. 2, an embodiment of a series wound motor is illustrated. The series wound motor comprises a stator module 110, a rotor module 120, a plurality of electrical brush modules 140 and a spark-proof mask 15. The spark-proof mask 15 should be resistant to high temperature and strong heat and capable of isolating sparks. Suitable material for producing the spark-proof mask 15, for example, is a thermosetting material or a bakelite. The stator module 110 has a hollow main body 111 for accommodating therein a magnetic winding (or working coil) 112, a front tray 131, a rear tray 132 and a wire 113. The rotor module 120 comprises a shaft 121, a commutator 122 and an armature winding (or rotor coil) 123. In this embodiment, there are two electrical brush modules 140 used, each comprising a brush element 141, a spring 144 and a coupler 145. The spark-proof mask 15 comprises a hollow cylindrical body 50 and two sockets 51 corresponding to the two brush elements 141. The hollow cylindrical body 50 is accommodated in the front tray 131 and has a surface 502 sustaining against a surface 1111 of the hollow main body 111 when the series wound motor is assembled.

The magnetic winding 112 is accommodated in the hollow main body as well as the rotor module 120 and electrically connected to the armature winding 123 in series. An external current is applied to the magnetic winding 112 so as to induce a magnetic field. The magnetic field is then provided for the rotor module 120 to rotate the shaft 121, which will be described in more details later. The front tray 131 is disposed at one side of the hollow main body 111 for supporting one end of the shaft 121 of the rotor module 120 while allowing the shaft 121 to rotate therein. The front tray 131 includes two slots 1311 for penetrating therethrough the two sockets 51 of the spark-proof mask 15, and the two brush elements 141 penetrate through the two sockets 51 and thus the two slots 1311, respectively. Further, there are two through holes 501 arranged in the wall of the hollow cylindrical body 50 and aligned with the sockets 51. Alternatively, the sockets 51 can be integrally formed with the hollow cylindrical body 50 and passages accessible to the internal space of the hollow cylindrical body 50 are reserved, like the function of the through holes 501 and the sockets 51. Since one end of the shaft 121 sleeved thereon the commutator 122 extends through the spark-proof mask 15, the brush elements 141 can reach the commutator through the sockets 51, slots 1311 and through holes 501. In order to assure of good electric contact between the brush elements 141 and the commutator 122, the springs 144 are coupled to and urge the brush elements 141 against the commutator 122. The springs 144 are made conductive so that the external current introduced from the couplers 145 can be transmitted to the commutator 122 via the springs 144 and the brush elements 141. For assembling the motor, the rear tray 132 is coupled to the hollow main body 111 from the opposite side of the hollow main body 111 for supporting the opposite end of the shaft 121 while allowing the shaft 121 to rotate therein. In this embodiment, both ends of the shaft 121 are preferably supported with insulators 1310 and 1320 before engaging with the front and rear trays 131 and 132.

For operating the motor, an external current is introduced into the commutator 22 through the conductive couplers 145, springs 144 and electrical brushs 141 to provide alternate current directions for the armature winding 123 in order to generate electromagnetic toque. Meanwhile, an external current is supplied to the magnetic winding 12 of the stator module 10 via the wire 113 to derive a magnetic field. In response to the magnetic field and the alternately changing current directions, the shaft 21 can continuously rotate in the same direction.

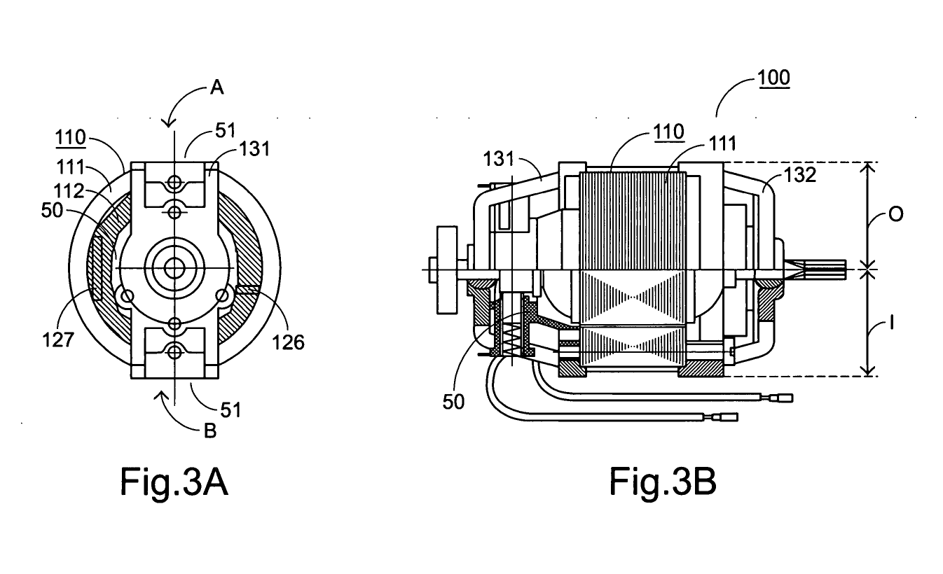

FIGS. 3A and 3B provides alternative views to illustrate the above-mentioned series wound motor. For making the figures neat and understanding, the electrical brushes are not shown in FIG. 3A, and in stead, arrows A and B are used to indicate the insertion of the electrical brushes.

The spark isolating function can be achieved by the present invention mentioned above because the spark-proof mask covers the contact portion where sparks possibly occur due to the abrasion between the electrical brush and the commutator. In this way, the sparks are confined within the spark-proof mask and prevented from striking other portions of the motor. For further assuring of the safety of the series wound motor, a thermal sensor 126 is preferably electrically connected to the magnetic winding 112 and a thermal fuse 127 is preferably arranged inside the magnetic winding 112.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A series wound motor comprising:
a stator module;
a rotor module comprising a shaft rotatably inserted into said stator module and a commutator sleeved around and rotating with said shaft;
at least one electrical brush module penetrating said stator module to be in contact with said commutator for introducing an external current to said commutator therevia; and
a spark-proof mask covering a contact potion of said electrical brush module and said commutator for isolating sparks occurring due to the abrasion between said electrical brush module and said commutator.

2. The series wound motor according to claim 1 wherein said spark-proof mask includes a hollow cylindrical body for covering said commutator.

3. The series wound motor according to claim 2 wherein said hollow cylindrical body includes at least one through hole in the wall thereof and said spark-proof mask further includes at least one socket attached to said hollow cylindrical body aligned with said through hole for receiving therefrom said electrical brush module, thereby allowing said electrical brush module to penetrate through said socket and said through hole to reach said commutator.

4. The series wound motor according to claim 3 wherein said hollow cylindrical body and said at least one socket are integrally formed.

5. The series wound motor according to claim 1 wherein said spark-proof mask is made of thermosetting material.

6. The series wound motor according to claim 1 wherein said spark-proof mask is made of bakelite.

7. The series wound motor according to claim 1 wherein said stator module comprises:
a hollow main body for accommodating therein said rotor module;
a magnetic winding accommodated in said hollow main body for providing a magnetic field for said rotor module in response to an applied current;
a front tray disposed at one side of said hollow main body for supporting one end of said shaft of said rotor module while allowing said shaft to rotate therein, and having at least one slot for penetrating therethrough said at least one electrical brush module to be in contact with said commutator; and
a rear tray disposed at the opposite side of said hollow main body for supporting the opposite end of said shaft while allowing said shaft to rotate therein.

8. The series wound motor according to claim 7 wherein said spark-proof mask is accommodated in said front tray and sustaining against said hollow main body, and one end of said shaft inserted into said hollow main body penetrates through both said spark-proof mask and said front tray.

9. The series wound motor according to claim 7 wherein said spark-proof mask comprises a main body accommodated in said front tray and at least one socket protruding from said main body and penetrating through said at least one slot.

10. The series wound motor according to claim 7 wherein said rotor module further comprises an armature winding electrically connected to said commutator in series and sleeved around said shaft for generating an electromagnetic torque in response to said external current and said magnetic field.

11. The series wound motor according to claim 1 wherein each of said at least one electrical brush module comprises:
a brush element to be in electric contact with said commutator;
a conductive coupler electrically connected to said conductive flexible element for introducing therefrom said external current; and
a conductive flexible element coupled to said conductive coupler for transmitting said external current therevia and urging said brush element against said commutator for facilitating the electric contact between said brush element and said commutator.

12. The series wound motor according to claim 11 wherein said brush element penetrates through said stator module and said spark-proof mask to be in contact with said commutator.

13. The series wound motor according to claim 11 wherein said conductive flexible element is a spring.
